(19) United States
(12) Patent Application Publication
(10) Pub. No.: US 2011/0225550 A1
(43) Pub. Date: Sep. 15, 2011

(54) SYSTEM AND METHOD FOR DISPLAYING AND NAVIGATING LIBRARY INFORMATION WITH A VIRTUAL LIBRARY COLLECTIONS BROWSER

(76) Inventor: Michael S. Creedon, Rochester, NY (US)

(21) Appl. No.: 13/046,232

(22) Filed: Mar. 11, 2011

Related U.S. Application Data
(60) Provisional application No. 61/313,699, filed on Mar. 12, 2010.

(51) Int. Cl. G06F 3/048

(52) U.S. Cl. 715/841

(57) ABSTRACT

A system and method of displaying and navigating library information includes the steps of: receiving, from a user, a selection of a category of library materials; displaying part of that category of library materials the order they appear in an indexed catalog system based on item subjects; and upon request, displaying to the user an adjacent section of library materials in the selected category. The user can also view images of covers and/or selected text from a selected item.

This application claims priority to U.S. Provisional Application Ser. No. 61/313,699, filed Mar. 12, 2010, the entire disclosure of which is hereby incorporated by reference.

### FIELD OF INVENTION

The present invention relates to the field of electronic and physical search, discovery, location, access and delivery of items held by libraries, archives and museums specifically, and by any warehouse of cataloged inventories generally, within a secure computing environment.

### BACKGROUND INFORMATION

Virtual search, discovery, location, access and delivery systems for library, archive and museum holdings are known in present state-of-the art to be Internet-based, and rely in essence on user keyword searching via a computer data-form entry of select terms. In keyword-based Internet searching of libraries, the traditional intellectual assets of serendipitous, secure and anonymous or confidential browsing are lacking in large degree. These assets are found in the traditional library shelf browsing of items arranged by an ontological subject organization, e.g., by the Library of Congress Classification Schema (LCC).

Keyword-based searching, e.g., as in a Google Books or Google Scholar keyword search, assumes users have specific terms in mind with which to initiate their inquiry, and keyword-based result sets only return items for research that are in some way directly inclusive of the specified keywords or somehow logically related according to a transformation of the specified keywords to other specifiable keyword sets. The user experience of randomly browsing a physical shelf of organized items presents users with a plurality of items related by a loosely coupled ontological relation rather than a restrictive terminological dependency. In addition, secure, and anonymous or confidential transaction processing over the Internet generates a library experience that more fully replicates the analog use of a real library.

### BRIEF SUMMARY OF THE INVENTION

An object and advantage of embodiments of the present invention is that it increases the likelihood of chance discovery based more fully on ontological relation, rather than on pre-selected terminologies or popularity algorithms, thereby providing the user with a valuable intellectual benefit provided by traditional browsing in a collection that newer keyword-based systems are lacking.

In accordance with a first embodiment of the present invention, a method of displaying and navigating library information includes: receiving, from a user, a selection of a category of library materials; displaying part of that category of the library materials in the order they appear in an indexed catalog system based on item subjects; and upon request, displaying to the user an adjacent section of library materials in the selected category. The method may further include receiving from a user a selection of one of the displayed library materials, and displaying an image of a cover of that selected library item, and/or portions of the text of that library item.

In accordance with a second embodiment of the present invention, non-transitory computer readable media are provided, having stored thereon, computer executable process steps, operable to control a computer to perform the method described above.

In accordance with a third embodiment of the present invention, a system for displaying library information and navigating library information is provided. The system includes a computer system including one or more computers. The computer system receives, from a user, a selection of one of a plurality of categories of library materials, and the computer system transmits information to a display device which is sufficient to display to the user a first plurality of library materials in the selected category. The library materials are displayed in sequence order according to a subject based indexed catalog system. The computer system further receives, from the user, a navigation request, and in response thereto, the computer system transmitting information to the display device which is sufficient to display to the user a second plurality of library materials in the selected category. The second plurality of library materials is adjacent the first plurality of library materials in the subject based indexed catalog system.

### BRIEF DESCRIPTION OF THE DRAWINGS

The present invention will be further described with respect to the following Figures, in which:

FIG. 1 shows how the LCC Call Number Schema is arranged by broad index classifications.

FIG. 2 shows how the category index “S” standing for “Agriculture” is further sub-classified in the LCC Call Number Schema.

FIG. 3 shows a schematic diagram of how a Virtual Library Collections Browser client-server system embodiment would operate at the level of logical groupings of users and items to accommodate Consortia of libraries collections and sub-collections variably accessible to sponsored users in user groups with specific authentication and authorization permissions to variously use the system.

FIG. 4 shows a schematic diagram of a preferred implementation of the Virtual Library Collections Browser user interface, a computer monitor displaying a plurality of library items, book covers displaying in catalog index order and browsable via touch-screen navigation controls, for handling transaction requests.

### DETAILED DESCRIPTION OF A PREFERRED EMBODIMENT

A Virtual Library Collections Browser: a system and method for constructing a virtual library experience that facilitates the traditional processes of serendipitous, anonymous or confidential and secure library browsing, discovery, access and delivery across various collections is provided. This browser provides:
(a) A computerized system and method for providing serendipitous library exploration and discovery of items based on browsing in sequence representations of items that are organized in sequences and groupings according to categories in an indexed cataloging system based on item subjects.
(b) A computerized system and method for providing anonymous or confidential library transaction processing based on the online encryption of transactions over the Internet.
(c) A computerized system and method for providing secure library transaction processing based on authentication and authorization policies enacted by hosting institutions to protect both user and item owner rights and responsibilities.

A user is presented with a display of categories of books or other cataloged items, and selects which category the user would like to explore further. The user may be presented with a display of sub-categories of the first category selection, and so on, until they drill-down to a suitable degree of specification for their topic of interest. The categories may be presented in a visual map of a collection's items by subjects, for example with the subject-based Library of Congress Classification (LCC) Schema used in cataloging the shelf locations of books, serials, and other library items according to LCC Call Number.

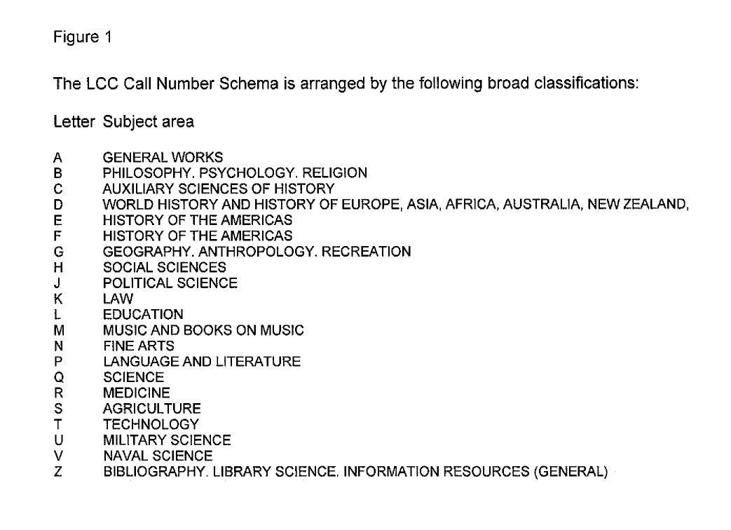

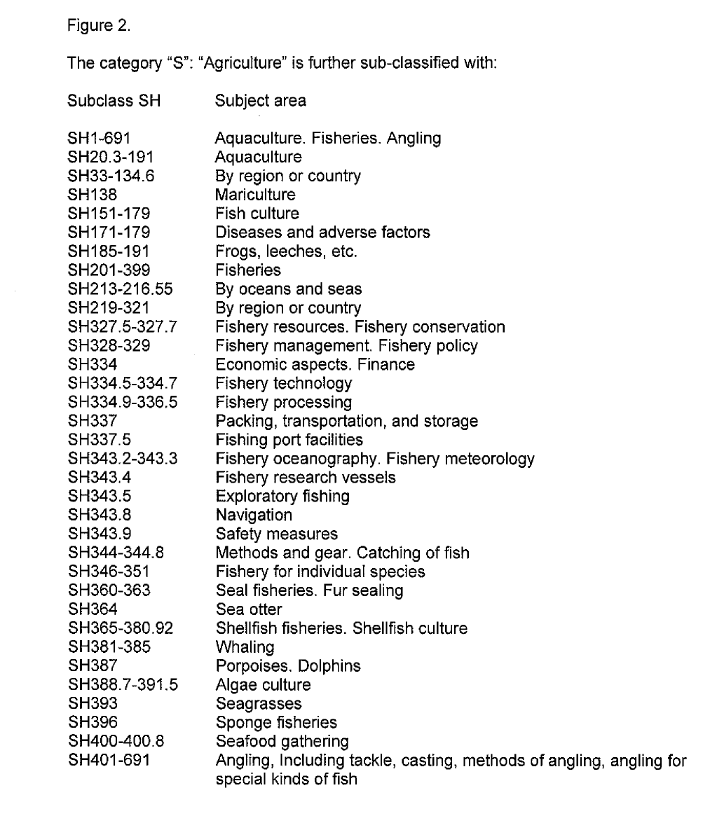

Broad subject-based classifications of items are presented in a map, guide or key, etc., along with corresponding index ranges, e.g., LCC Call Number ranges that cover these classifications. When the user is satisfied with their degree of specificity in using the map to enter the viewing of items, the user selects to enter a new display of a plurality of books or other cataloged items presented in the order of their classification by subject. For example, (see FIG. 1 and FIG. 2 depicting the LCC Call Number Schema), to enter viewing books on “Exploratory Fishing”, the user would start viewing at the LCC Call Number range beginning with “SH343.5” after having narrowed the range from a more general classification of “Agriculture” under “S” in the LCC Call Number Schema.

The display of a plurality of books or other cataloged items is sequential in a visual representation of each work, such that each work is preceded and succeeded by the work that comes before or after that given work in the classification schema's ordering by index, i.e., for library items this might be the LCC Call Number in A1-Z9 alphanumeric order. For archive items this might be an Encoded Archival Description (EAD) unique identifier in alphanumeric order by sub-collection, or in a museum this might be a unique Accession unique identifier that indicates the sub-collection and artifact acquisition date.

When a user finds a work to further explore, the user selects the representation of the work and further identifying and descriptive metadata based on the classification schema is presented so the user can decide if they want to proceed to request a transaction on the work. If the user selects to request a transaction, they will be presented with a map, guide or key for learning the location of holding or host libraries or other institutions, and to further decide from which of these institutions the user would like to make the transaction request.

Requests for item transactions may include inquiry on the item's location in holding or host institutions, item holds for personal pickup, interlibrary loan delivery to a sponsoring library, electronic or postal delivery to the user, request for on-demand acquisition from a specific host library, print-on-demand and delivery, copyright compliant photocopying of a portion of the item for electronic delivery, e.g., a chapter or article from a book or journal, or a license-based electronic delivery of items (e.g., licensed journal articles) that the user has rights and credentials to view and receive. In addition, web links to vendor or other contact information may be presented by which the user may pursue ordering the item or its facsimile in accordance with vendor policy. Web links to export item data to email and other communication media are also possible.

If the user then would like to return to browsing, they can opt to go back to where they left off in the subject range they were exploring, or may choose to start again from the beginning. In this way, a user can thumb through or drill down into a given classification range, and discover chance or anomalous items the user would not normally know existed or were available within the same ontological subject range, thus creating the virtual experience of serendipity.

In the example in FIG. 1, “Agriculture” as a subject has an LCC Call Number header “S”. A user may want to find works on Pacific Northwest fishing, but not know any keywords relevant to the field, as they may be novice to the subject. So, using the classification map, see FIG. 2, if the user selects to explore the subject “Agriculture” sub-classification “Exploratory Fishing”, via the Call Number header “SH343.5” they may discover and browse an ontologically related set of adjacent items they would not normally have been able to find if they had to enter specific keywords or terminologies to gain knowledge of available items.

Sometimes the LCC Call Number Schema can present works in sequence for example that one might never have guessed were ontologically related, as in the case of a hypothetical book containing poems and travel journal entries on fishing of a famous Northwest seafarer. The possibility of rich chance discovery via this method is increased greatly by relying on the subject classification system to ground the presentation of browsable items rather than relying on search result sets of keyword combinations.

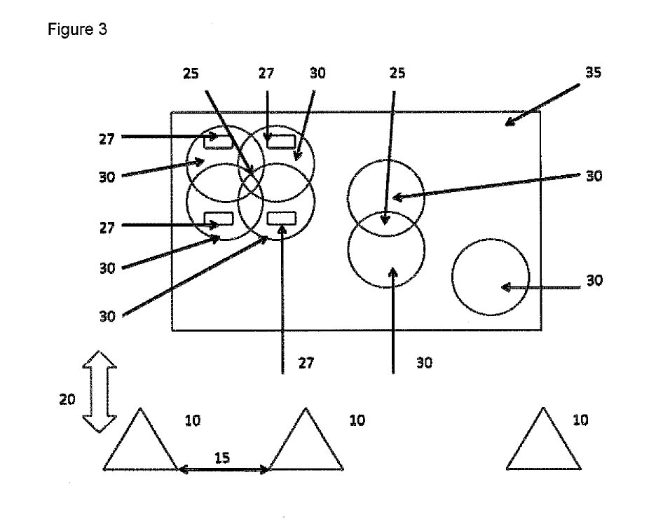

Referring now to FIG. 3, User_{N} 10 gains peer-reviewed and authorized membership in Virtual Library Collections Browser client-server 20 system via user-sponsoring Consortia_{N} 25 member libraryᵢ 30 where libraryᵢ 30 represents each library, archive, museum or other warehouse of an orderly cataloged Collectionⱼ 27 of Item_{z} 12 that is eligible to participate in sponsoring User_{N} 10 membership. The functionality of communicating information between a client and server via a browser, and for rendering a display within a browser with information from a server (or other architecture) is well known and will not be described herein. In this regard, the present invention is not intended to be limited to any particular computer or network architecture, though examples are provided herein.

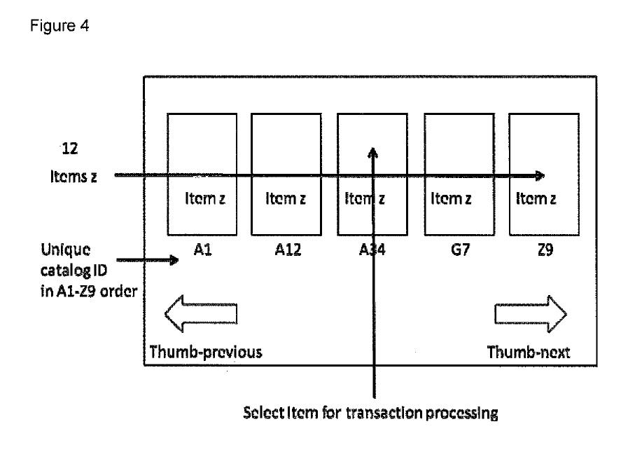

Referring to FIG. 4, Item_{z} 12=All objects (physical, electronic, or virtual) for which User_{N} 10 is authorized by its sponsoring libraryᵢ 30 to search, browse, discover, and request access and delivery from a select set of any other libraryᵢ₂ 30 within Master Library_{N} 35. Object types include a plurality of objects, such as books, serials, other texts, artifacts or images of artifacts, other objects or images of other objects, other images, audio, film, video, maps, data, data sets, applications, other files or bit streams, etc.

As illustrated in FIG. 3, libraryᵢ 30=Σᵢ₌₁_{_{→}}_{∞}{libraryᵢ 30, (Collection_{j 27})∪(Collection_{j2 27})∪(Collection_{j3 27})}, meaning each member libraryᵢ 30 is comprised of a set of sub-collections, (Collection_{j 27}), which are in turn comprised of items, Items_{z} 12.

Consortia_{N} 25=Σᵢ₌₁_{_{→}}_{∞}{(libraryᵢ 30)∪(libraryᵢ₂ 30)∪ . . . ∪(library_{i∞} 30)}−[{(libraryᵢ 30)∪(libraryᵢ₂ 30)∪ . . . ∪(library_{i∞} 30)}∪{(library_{iP} 30)∪(library_{iQ} 30)∪ . . . ∪(library_{iR} 30)}], meaning all Items_{z} 12 in all Collectionsⱼ 27 in all Consortia_{N} 25 member libraries library_{i∞} 30 are algebraically joined in their mathematical union (∪) and exclude items, via mathematical disjunction (∩), unique to non-Consortia-member libraries.

Master Library_{N} 35=Σ_{N=1} _{_{→}}_{∞} (Consortia_{N} 25).

User_{N} 10 is authorized by its sponsoring libraryᵢ 30 to search, browse, discover, and request access and delivery from a select set of any other libraryᵢ₂ 30 within Master Library_{N} 35 based on policies for Permissions_{M} agreed upon by Consortia_{N} 25

Any library may belong to a plurality of Consortia_{N} 25 with distinct policies for Permissions_{M}, including authentication rights and procedures and concomitant authorizations for user groups, UserGroup_{M} 15.

In the preferred embodiment, User_{N} 10 securely logs on to Master Library_{N} 35, for example with SSL-PKI (Secure Socket Layer Public Key Infrastructure) encrypted credentials, as part of UserGroup_{M} 15 with variable peer-reviewed rights to search, browse, discover, access, and receive delivery of all Items_{z} 12 housed or hosted by all Joined {libraryᵢ 30, (Collectionⱼ 27)} to which UserGroup_{M} 15 is permitted.

The preferred embodiment of the user device is a navigable visual representation of items (e.g., using the Syndetics Solutions book cover-bibliographic data service) in cataloged sequence, e.g., a navigable computer monitor based on touch screen technology, mouse control technology, or a virtual reality three dimensional representation using navigation goggles or gloves, or some other control device, for example.

When a user selects a specific item, more bibliographic data (identifying and descriptive metadata) will be presented on that item so the user can decide if they want to pursue an access and delivery transaction. For example, metadata might include the Dublin Core standard including Item Title, Author or Creator, Creation Date, Object Type, Object Type, Material Type, Copyright information, Subject classification terms, and a brief description of the content of the item, along with the item's unique identifier, e.g. a transformed LCC Call Number.

When a user selects to request a transaction for a specific item, they are presented with a display of available options for access and delivery, as described earlier. The nearest to farthest locations to the user computer device of the holding or host libraries or institutions can be retrieved via a GIS-based lookup in the Master Library holdings database on the server, “in the clouds” (i.e., via a cloud computing environment) or via a link to some other global holdings database service such as the Library of Congress or the OCLC (Online Computer Library Consortium) service Worldcat.org. Once the user selects to which holding or host library or institution to direct the request, a link to that library or institution can be initiated to begin processing transactions.

The user enters the visual representation of a plurality of books or other cataloged items via a first point-of-entry, and can continue to browse forward or backward in the ordered sequence indefinitely. In the preferred embodiment the user uses an ID map or subject guide to the collection set at hand, for example uses a LCSH based thesaurus of subject headings (Library of Congress Subject Headings thesaurus) linked to LCC Call Number ranges.

In alternate embodiments the user could enter the collection with a specific identification number, e.g. a LCC Call Number, or could link to the Virtual Library Collections Browser as a service from a local library management system (LMS) lookup, as in a local institutional holdings catalog of some kind. Once the identification number of the first point-of-entry is determined, the browsing forward and backward around the specific ordered range can begin, e.g. the A1-Z9 alphanumeric list order.

In the preferred embodiment the Virtual Library Collections Browser is data-driven, and the presentation of successive items in collections is comprised of data-driven processing, rather than for example, based on images of shelf collections. The server A1-Z9 list of items is comprised of a hierarchal relational structure of items in sub-collections of collections, of member libraries of consortia of the Master Library.

The server A1-Z9 list is structured according to an ERD (Entity Relationship Diagram) relational database model where each item has a unique identifier constructed via a transformation of the local library identification number, e.g., by pre-pending a collection code and timestamp to the LCC Call Number. The local library or institution (or the Library of Congress, or OCLC) can provide the server with exports of its holdings data to enable building of the server database, and the transformation of the identification number can happen via an automated import process.

When a local member-sponsoring institution joins a consortium, whether a public or private library, archive or museum, a government institution, or a private corporation or not-for-profit or community organization, each user of the Virtual Library Collections Browser in conjunction with the local institution must be sponsored, via peer-reviewed policy for the consortia, or else the user would have only restricted guest-level access to the system.

All participating libraries must agree and comply with a system of auditable security as a condition of membership, and in accord with the ALA Code of Ethics, which has specific public policies for handling the history of patron library use. This is meant to comply with governing law and policy, and to remain accountable to users that the treatment of their identity and the intellectual content of their library use are private, to the fullest extent as governed by law. For example, a cancer patient may not want anyone to know his or her condition and hence may want secure privacy, and verifiable confidentiality of records of her library research on the subject of battling and surviving cancer.

A tiered level of security (for example via enhanced logon technology) will provide all good faith efforts to prevent intrusion or breach, and relieve everyday Internet users of the burden of unverifiable confidence in online transactions. Upon sponsorship by a host library or institution, all users are trusted and their non-intrusive and legal participation is assumed, and is verifiable in auditing practices in accordance with governing law.

In SSL PKI encryption, as for example commonly used by banks via the Symantec service Verisign, only the Internet service end user and the “blind” server know how to decrypt the session content (i.e., intellectual content) that occurs between the user and the blind server. Session information transfer at the level of intellectual content is encrypted so that not even the blind server or service provider can decrypt the content without an auditable trace. Most banks require their data warehouse vendors to provide this kind of assurance so banks can maintain a credible and verifiable trust relationship with their clients.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A computerized method for displaying library information and navigating library information comprising performing, with a computer or computers, the steps of:
receiving, from a user, a selection of one of a plurality of categories of library materials;
displaying to the user a first plurality of library materials in the selected category, the library materials being displayed in sequence order according to a subject based indexed catalog system;
receiving, from a user, a navigation request, and in response thereto, displaying to the user a second plurality of library materials in the selected category, the second plurality of library materials adjacent the first plurality of library materials in the subject based indexed catalog system.

2. The method of claim 1, further comprising, performing, with the computer or computers, the steps of:
receiving, from a user, a selection of one of the first plurality of library materials; and
displaying an image of a cover of said selected one of the first plurality of library materials.

3. The method of claim 1, further comprising, performing, with the computer or computers, the steps of:
receiving, from a user, a selection of one of the first plurality of library materials;
displaying an image of a cover of said selected one of the first plurality of library materials along with descriptive metadata for said selected one of the first plurality of library materials.

4. The method of claim 1, wherein the subject based indexed catalog system is selected from the group consisting of: a Library of Congress Classification (LCC) Schema for assigning LCC Call Number unique identifiers to distinct library items; a Dewey Decimal System for assigning Dewey Decimal unique identifiers to distinct library items; and an Archive's Encoded Archival Description (EAD) unique identifier.

5. The method of claim 1, wherein the subject based indexed catalog system is a set of unique identifiers indexed according to subject cataloging of distinct items in a warehouse or archive of such cataloged items.

6. The method of claim 5, wherein the set of unique identifiers are a set of Museum's Accession unique identifiers.

7. The method of claim 1, wherein the steps of receiving and displaying are encrypted.

8. The method of claim 7, wherein the user logs on securely to the client-server system for the user session to initiate encrypted receiving and displaying.

9. The method of claim 1, further comprising, performing, with the computer or computers, the steps of:
receiving, from a user, a selection of a first option, the first option being an option to view transactions options available for the one of the first plurality of library materials; and
displaying a hyperlinked list of further transaction option paths to take regarding said selected one of the first plurality of library materials.

10. The method of claim 1, further comprising, performing, with the computer or computers, the steps of:
displaying a hyperlinked list of options, the options comprising:
(a) to return to the last displayed plurality of library materials adjacent the first plurality of library materials in the subject based indexed catalog, or
(b) to return to the home display to enter another selection of one of a plurality of categories of library materials and thereafter displaying to the user a first plurality of library materials in the selected category, the library materials being displayed in sequence order according to a subject based indexed catalog system, or
(c) to securely log off the system and exit.

11. The method of claim 2, further comprising, performing, with the computer or computers, the steps of:
receiving, from a user, a selection of the option to view transactions available for the one of the first plurality of library materials;
displaying a hyperlinked list of icons representing further transaction option modules available to select regarding said selected one of the first plurality of library materials, where the transaction option modules for said selected library material transactions to select include one or more of the following:
(a) inquiry on the selected library material's location in holding or host institutions,
(b) a request to hold the selected library material for personal pickup,
(c) a request for interlibrary loan delivery of the selected library material to a sponsoring library,
(d) electronic or postal delivery of the selected library material to the user,
(e) request for on-demand acquisition of the selected library material from a specific host library,
(f) print-on-demand and delivery of the selected library material,
(g) copyright compliant photocopying of a portion of the selected library material for electronic delivery,
(h) a license-based electronic delivery of the selected library material, wherein the user has rights and credentials to view and receive via the selected library material.
(i) ordering from a vendor the selected library material in accordance with vendor policy.
(j) exporting of data regarding the selected library material to email and other communication media.

12. The method of claim 1, wherein library material includes items selected from the group consisting of books, serials, other texts, artifacts or images of artifacts, other objects or images of other objects, other images, audio, film, video, maps, data, data sets, applications, other files and bit streams, and combinations thereof.

13. The method of claim 11, wherein the transactions option module includes icons of the said available transactions, the method further comprising selectively displaying said icons based upon a secure data-query into the server regarding the user's level of authorization corresponding to authentication credentials within an institution-sponsored user group, with user group permissions set for all users with the same user group in the same networked library-institution peer-reviewed consortium.

14. The method of claim 13, wherein system use permissions can be customized to the individual user and item level.

15. The method of claim 11, wherein the available transactions are initiated and processed via the display of the required input and output over a secure Internet connection to the local consortial host library of other item holding institution or warehouse, or to other transaction processing service modules, that can be securely connected and function securely with the system comprising this invention.

16. Non-transitory computer readable media, having stored thereon, computer executable process steps, operable to control a computer to perform the steps of:
receiving, from a user, a selection of one of a plurality of categories of library materials;
displaying to the user a first plurality of library materials in the selected category, the library materials being displayed in sequence order according to a subject based indexed catalog system;
receiving, from a user, a navigation request, and in response thereto, displaying to the user a second plurality of library materials in the selected category, the second plurality of library materials adjacent the first plurality of library materials in the subject based indexed catalog system.

17. The Non-transitory computer readable media of claim 16, having stored thereon, computer executable process steps, operable to control a computer to perform the further steps of:
receiving, from a user, a selection of one of the first plurality of library materials; and
displaying an image of a cover of said selected one of the first plurality of library materials.

18. The Non-transitory computer readable media of claim 16, wherein the subject based indexed catalog system is selected from the group consisting of: a Library of Congress Classification (LCC) Schema for assigning LCC Call Number unique identifiers to distinct library items; a Dewey Decimal System for assigning Dewey Decimal unique identifiers to distinct library items, and an Archive's Encoded Archival Description (EAD) unique identifier.

19. A system for displaying library information and navigating library information comprising:
a computer system including one or more computers, the computer system receiving, from a user, a selection of one of a plurality of categories of library materials, the computer system transmitting information to a display device which is sufficient to display to the user a first plurality of library materials in the selected category, the library materials being displayed in sequence order according to a subject based indexed catalog system, the computer system receiving, from the user, a navigation request, and in response thereto, the computer system transmitting information to the display device which is sufficient to display to the user a second plurality of library materials in the selected category, the second plurality of library materials adjacent the first plurality of library materials in the subject based indexed catalog system.

20. The system of claim 17, wherein the computer system receives selections, and transmits information, over the internet.
